(19) United States
(12) Patent Application Publication
(10) Pub. No.: US 2011/0197571 A1
(43) Pub. Date: Aug. 18, 2011

(54) METHOD AND ARRANGEMENT FOR DETECTING PARTICLES

(75) Inventors: Jacobus Hendrik Visser, Farmington Hills, MI (US); Peter Jozsa Mårdberg, Goteborg (SE); Doina Lutic, Lasi (RO); Anita Lloyd Spetz, Linkoping (SE); Mehri Sanati, Lund (SE)

(73) Assignees: VOLVO TECHNOLOGY CORPORATION, Goteborg (SE); FORD GLOBAL TECHNOLOGIES, LLC, Dearborn, MI (US)

(21) Appl. No.: 12/919,566

(22) PCT Filed: Feb. 27, 2008
(86) PCT No.: PCT/SE2008/050215

§ 371 Date: Mar. 14, 2011

(51) Int. Cl. F01N 3/021; G01M 15/10

(52) U.S. Cl. 60/311; 73/23.33

(57) ABSTRACT

The present invention relates to a method for detecting particles and a particle sensor arrangement. More specifically, the present invention relates to a method and arrangement for detecting particles in a gas flow, e.g. from a diesel combustion engine. The method comprises the steps of; forcing a particle build up on a sensor element of a particle sensor arrangement by regulating the sensor element to a second temperature; wherein the second temperature is lower than a first temperature, the first temperature being the gas flow temperature. Additionally is the particle build up detected at the sensor element by means of a detector. The present invention provides for an accurate method and arrangement to detect and thereby measure particles present in a gas flow, e.g. from a combustion engine.

### TECHNICAL FIELD

The present invention relates to a method for detecting particles and a particle sensor arrangement. More specifically, the present invention relates to a method and arrangement for detecting particles in a gas flow.

### BACKGROUND OF THE INVENTION

There is an increasing need for environmental friendly vehicles, engines, fuel and vehicle exhaust gas cleaning arrangements, all serving the purpose of striving towards a less harmful impact on the environment. In the field of vehicle exhaust gas cleaning, the industry faces the delicate balance of providing an adequate effect from the engine, which is demanded by the consumers, while not emitting to high quantities of harmful emissions, such as NOx, COx, hydrocarbons, particulates and the like. The demand to have a combustion engine and an exhaust gas cleaning system which strives towards zero emission are not only driven by the customers but also by legislators. Hence an increased awareness of the need for environmental friendly solutions in the vehicle industry is crystallized in a more restrictive legislation with respect to permitted emissions. An example of such legislation is the need for on-board diagnostics (OBD), although not implemented around the world yet. These restrictions provide new challenges and opportunities to the vehicle industry.

In order to provide a proper exhaust gas cleaning system, the inventors have found that a key issue is to satisfy the need for proper detection and registration of harmful pollutants in the exhaust gas emitted from the vehicle during use, e.g. when driving a vehicle. If this need can be met, the vehicle engine can be fine tuned with the input from such detection, to emit less pollutant and to consume less fuel. Further can equipment serving the purpose of reducing the emission be adjusted, replaced or otherwise provided for, so as to reduce the emission. One way of satisfying the need for proper detection is to provide for a sensor which can detect the specific pollutant which is the object for reduction.

One illustrative example of this problem is published in the patent publication of US 2006/0289308 A1, in which a sensor comprising a sensor element arranged in an inner chamber. An outer chamber, disposed around the inner chamber, protects the sensor element by substantially redirect the exhaust gas flow in the inner chamber. Additionally is a sintered metal filter arranged to trap any particulate matter in the exhaust gas flow to prevent the sensor from fouling, which in evidently ends with a decreased accuracy of the sensor.

However, when there is a need to detect particulate matters in an exhaust gas, which in itself is known to cause fouling, or even harm, to sensors, this objective becomes more difficult to fulfill. Especially for diesel engines which are specifically known to have problem with particulate matters in the exhaust gas. The other extreme is that conventional sensors either not detect a sufficient amount of particulate matter to provide for a meaningful reading, or in some applications they may foul due to an overload of particulate matter. In either case, sensors and methodology for detecting particulate matter in exhaust gas needs to be developed further.

### SUMMARY OF THE INVENTION

The above mentioned drawbacks are at least partly solved by a method for detecting particles in a gas flow, such as an exhaust gas of a combustion engine, preferably a diesel engine. The method comprises the steps of; providing at least one particle sensor arrangement comprising a sensor element, the sensor element being at least partly exposed to a gas flow, wherein the gas flow comprises a first temperature T1 in the proximity of the sensor element. The method further comprises the steps of; forcing a particle build up on the sensor element of the particle sensor by regulating the sensor element to a second temperature T2; the second temperature T2 being lower than the first temperature T1; and in that the particle build up is detected at the sensor element by means of a detector. The present invention provides for an accurate way of detecting particles present in a gas flow from e.g. combustion, preferably a combustion engine, preferably a diesel engine. The present invention utilizes the phenomenon known as thermophoresis in a new and inventive manner to detect and to provide for an accurate measurement of a particle build up (deposition).

The detection of a particle build up can be made in different ways, in an embodiment of the present invention; the detection of particle build up is done by means of detecting the resistance between a first and a second electrode arranged on the sensor element. As will be described in greater detail below, the first and the second electrode can be arranged as finger electrodes, extending into each other. However, other forms are also possible such as spirals or the like.

The second temperature T2 at the sensor element can be regulated by means of providing a temperature control arrangement to the sensor element. The temperature control arrangement can be anything which will effectively keep the sensor element with a temperature below the gas, so as to utilize the inventive concept. Example of such a temperature control arrangement is a cooling element, heat exchanger, or the like. A preferred temperature control arrangement is a cooling element, since the temperature can be efficiently controlled in a dynamic way, thereby increasing the flexibility of the method. The second temperature T2 is advantageously arranged to be about 5-250° C., preferably 5-150° C. less than the first temperature T1. One way of cooling with a heat exchanger is to provide said heat exchanger with a circulating cooling liquid. In cases where the present invention is used in combination with a combustion engine, preferably on a vehicle, such cooling liquid may appropriately be retrieved from the combustion engine or the vehicles cooling system, if such cooling system comprises a circulating cooling liquid.

The method according to one embodiment of the present invention further comprises the step of; removing the particle build up at the sensor element by means of, direct or indirect, heat the sensor element so as to combust, and thereby remove, substantially all particles of the particle build up at the sensor element. This step ensures that the sensor arrangement always is kept in its best operating mode. One preferred way of doing this is by means of convection from a heater arranged to the sensor element. The removing of the particle build up can further preferably be initiated when the particle build up has reached a predetermined threshold value.

Advantageously can the method comprise an initial step of calibrating the sensor arrangement towards a calibration gas flow, the calibration gas flow being created from the combustion of a mixture of a fuel gas and an oxidizing gas with a predetermined ratio. The predetermined ratio is selected to fit the detection of the particles in the gas flow. This initial calibration step has been found to be very useful since it permits the sensor to be fine tuned to e.g. a specific particle number size distribution, specific for the particles intended to be detected. Deposition of unwanted particles can thereby be reduced. The fine tuning of the sensor can be implemented by changing parameters such as; type of surface treatment of the sensor element, type of detector used, distance between electrodes (when such detector is used), area of the sensor element and the electrodes, type of material used as sensor element, time interval for regeneration of the sensor, temperature difference between the gas flow and the sensor element, etc.

The present invention further relates to a particle sensor arrangement for detecting particles in a gas flow, e.g. from a combustion engine, preferably a diesel combustion engine. The arrangement comprises; a sensor element to capture and hold at least a part of the particles of the gas flow, wherein the gas flow comprises a first temperature T1 in the proximity of the sensor element, a detector, arranged to detect a particle build up on the sensor element. The sensor element is arranged to a temperature control arrangement, and the temperature control arrangement being arranged to reduce the temperature of the sensor element so that during detection, the sensor element comprises a second temperature T2 which is lower than the first temperature T1 of the gas flow at the sensor element.

The temperature control arrangement is arranged to lower the second temperature T2 at between 5-250° C., 5-150° C., or least 5° C., preferably at least 20° C., more preferably at least 30° C., lower than the first temperature T1. The sensor element can further comprise a first surface; the first surface can contain or be coated with a noble metal, such as platinum, palladium or any other base metals with catalytic properties, to catalyze the combustion of the particles and/or to optionally improve the sensing capability of the sensor due to increased conducting properties of the sensor element.

In an embodiment of the present invention, the detector is arranged on the sensor element. The detector can comprise a first and a second electrode wherein the resistance between the first and second electrode is detected. As the particle build up increases on the surface of the sensor element, the resistance of between the first and the second electrode will change. As an example and as will be described below, the resistance decreases as electrically conducting particles deposit on the sensor element, however in special cases the deposition of particles can be measured as a resistance increase.

The present invention further relates to an engine exhaust gas system comprising the particle sensor arrangement as described above, both with reference to the method and the arrangement. The engine exhaust system comprises an inlet opening and an outlet opening, wherein the inlet opening is intended to be connected to an engine gas exhaust port. The engine exhaust system can further be equipped with a diesel particle filter and in that the particle sensor arrangement is arranged between the inlet opening and the diesel particle filter. Optionally may the particle sensor arrangement be positioned between the outlet opening and the diesel particle filter. The advantages of these different embodiments will be described in greater detail below. The engine exhaust gas system can advantageously comprise at least one, preferably at least two particle sensor arrangements. Optionally, the at least two particle sensor arrangements are positioned on either side of the diesel particle filter, i.e. upstream or down stream of the diesel particle filter.

The present invention further relates to a vehicle comprising a diesel engine and the engine exhaust gas system as described above.

It is to be understood that the method and arrangement for detecting particles in a gas flow, can be utilized in any gas flow, such as a gas flow from a combustion, e.g. at a power plant, disposal plant, thermal power station, coal power plant, central heater, heating boiler or the like. Even particles in gas flows in the ambient environment can be detected. As an example; A particle sensor arrangement can be positioned on the roof top of a building to measure desired particles. Optionally and/or additionally they may be used in combination with a combustion engine such as a fossil fuel engine, e.g. a diesel engine or optionally such as a biomass fuel engine or the like, preferred combustion engine is a diesel combustion engine. Appropriate combustion engines can be present in lorries, trucks, cars, trains, aircrafts, boats, diesel driven electrical power plants, lawn movers, etc. The preferred particles to detect in the method and arrangement as described herein are soot particles. However other particles could be detected using the present invention, such particles are particles from biomass combustion boiler and/or biomass gasification boiler (in order to improve the upstream of raw product gas from a biomass gasifier in a downstream system to provide added value product), dust, pollen, color pigments, particles from break systems on vehicles, tire particles from vehicles, or the like.

The particle sensor arrangement and method has been described above in combination with a diesel filter. However, a particle sensor arrangement and method can be used together with any particle filter suitable for the purpose. Examples of such particle filters are vacuum cleaning particle filters, filters of protective masks, e.g. gas masks, ventilation air inlet and/or outlet filters on vehicles, buildings or the like.

A particle sensor arrangement according to the present invention can in some embodiments further be fully or partly integrated with a particle filter, such as a particle filter mentioned above

### BRIEF DESCRIPTION OF THE DRAWINGS

The present invention will be described in greater detail with reference to the accompanying figures, wherein;

FIG. 1 shows a schematic overview of an engine connected to an exhaust gas system arranged with two particle sensor arrangements, according to the present invention.

FIG. 2 shows a cross section of an exhaust gas pipeline and a particle sensor arrangement, according to the present invention.

FIG. 3 shows the embodiment of the particle sensor arrangement as shown in FIG. 3, according to the present invention.

FIG. 4 shows a different embodiment of a particle sensor arrangement, according to the present invention.

FIG. 5 shows a particle distribution of the simulation gas used when evaluating and calibrating the particle sensor arrangement, according to the present invention.

FIG. 6 shows the resistance logged as a function of time when evaluating a particle sensor arrangement, as shown in FIG. 4, with different distances between the first and the second electrode of the resistance detector.

FIG. 7 shows the resistance logged as a function of time when evaluating a particle sensor arrangement, as shown in FIG. 4, at different gas concentrations.

### DETAILED DESCRIPTION OF PREFERRED EMBODIMENTS

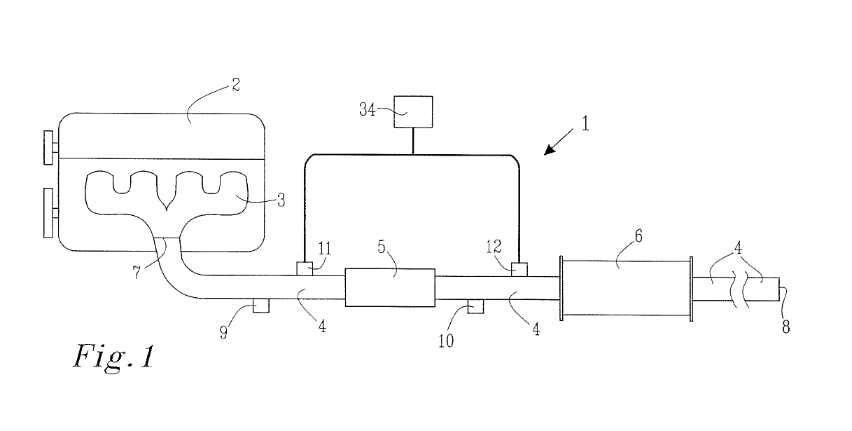

FIG. 1 show a schematic illustration of an exhaust gas system 1 connected to a diesel engine 2 at an engine exhaust gas port 3. Such an exhaust gas system 1 is preferably used in vehicles, such as trucks, boats, cars, trains, aircrafts or any other appropriate vehicle. The exhaust gas system 1 comprises, in the shown embodiment, of an exhaust gas pipeline 4, a diesel particle filter 5 and a muffler 6. The exhaust gas pipeline 4 comprises an inlet opening 7, through which the exhaust gas from the engine 2 enters the exhaust gas system 1, and an outlet opening 8, through which the exhaust gas exit the exhaust gas system 1 to the ambient air. A first and a second pressure sensor 9, 10 are arranged on respective side of the diesel particle filter 5. Additionally are a first and a second soot particle arrangement 11, 12, according to the present invention, arranged on respective side of the diesel particle filter 5. Although the present invention is herein described with reference to a soot particle sensor method and arrangement, the examples described are to be considered as non limiting in the sense of which kind of electrically conducting particle that can be detected, utilizing the present invention. The first and a second soot particle arrangement 11, 12 is connected to a computer 34, which can log, compare, act or in other ways utilize the detected results from the first and second soot particle arrangement 11, 12. The described first soot particle arrangement 11 can be identical to the second soot particle arrangement 12, or they may be different, according to the different embodiments described within the boundaries of the present invention. The soot particle arrangement and a method for detecting soot particles in the exhaust gas will hereafter be described in greater detail.

One advantage of putting a soot particle sensor arrangement, according to the present invention, upstream of the diesel particle sensor, is that the data logged in this position can specifically be used to detect a proper moment to clean the diesel particle filter. Conventionally this is done by means of the pressure sensors 9, 10, however, this detection method has shown to be inadequate. A combination of soot particle sensor arrangements 11, 12 and pressure sensors 9, 10 are however very advantageous, since surprisingly accurate predictions can be made. By better predict the proper moment to clean the diesel particle filter, fuel and energy is saved, and thereby also wearing on the equipment and the environment.

By putting a soot particle sensor arrangement, according to the present invention, downstream of the diesel particle sensor, a very accurate detection of unwanted concentrations of soot particles can be detected in the environment after the diesel particle filter, permitting the computer 34 to instantly act upon the detection of the unwanted concentration of soot particles by e.g. send an alert signal to the driver, or to adjust the combustion of the engine to reduce the amount of soot particles. Such an adjustment can be to significantly lower the output effect of the engine.

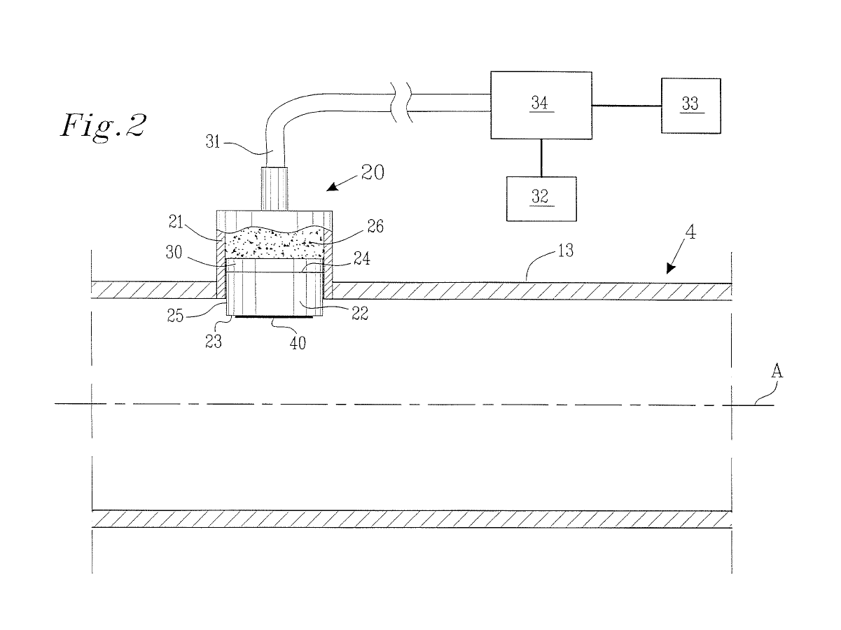

FIG. 2 shows a cross section of a part of the exhaust gas pipe line 4, comprising an longitudinal direction A, shown with an envelope wall 13, and a soot particle sensor arrangement 20, according to one embodiment of the present invention. More specifically, the soot particle sensor arrangement 20 partly extends through the envelope wall 13 of the exhaust gas pipe line 4, to reach inside the exhaust gas pipe line 4 and be exposed to the exhaust gas flowing through the exhaust gas pipe line 4. As is understood when reading this description, the soot particle sensor arrangement, according to the present invention, only needs to be in fluid communication with the exhaust gas pipeline 4 so that at least a part of the soot particle sensor arrangement 20 is able to contact the exhaust gas. Each component, and its function, of the soot particle sensor arrangement 20 now are described.

The soot particle sensor arrangement 20 comprises a protective cover 21 to protect the vital parts of the soot particle sensor arrangement 20 and to facilitate installation of the soot particle sensor arrangement 20 to the exhaust pipeline 4. The protective cover 21 is made to withstand high temperatures and to be insulating. A single piece of material can be used, or a laminated material, e.g. of a high temperature resistant material and an insulating material, arranged together with a material which is easy to attach to the exhaust pipe line.

A sensor element 22 comprising an outer detection surface 23, facing towards the inner of the exhaust gas pipe line 4, and thereby the exhaust gas, and an inner surface 24, facing towards the interior of the soot particle sensor arrangement 20. The sensor element 22 serves the purpose of providing a suitable surface for a particle build up, i.e. to collect a plurality of particles to perform measurements of the particles. As will be understood, the form the sensor element 22 can vary, in the shown embodiment of the present invention, the sensor element 22 comprises a substantially cylindrical form, in which the inner surface 24 and the outer detection surface 23 is connected with an envelope surface 25. Appropriate material for the sensor element can e.g. be chosen from aluminum oxides, semi conducting material such as silica carbide or the like. An important property is for the material to be able to conduct heat, to and away, from the outer detection surface 23.

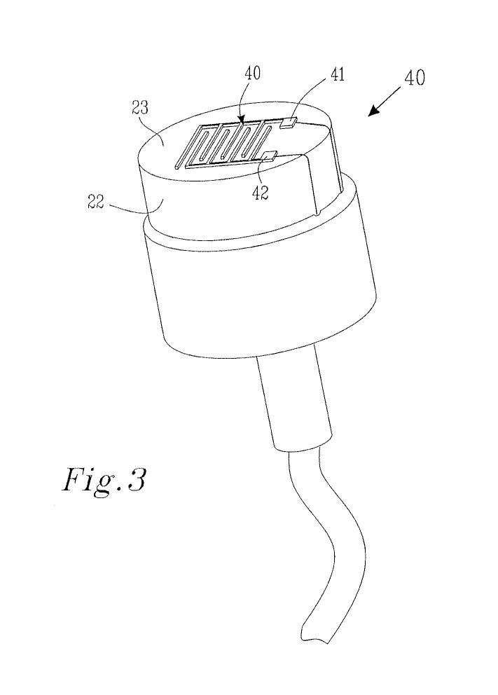

The outer detection surface 23 is in the shown embodiment of the present invention substantially horizontal, with respect to the longitudinal direction A and the exhaust gas flow. It may be appropriate to angle the outer detection surface 23 with respect to the longitudinal direction A, appropriate angles may be from 0°-90°, note that the outer detection surface 23 of the shown embodiment comprises an angle of 0°. More specifically, appropriate angles may be 0, 10, 20, 30, 40, 50, 60, 70, 80 or 90°, or an angle between these given points. A detector in the form of a first and a second electrode can be arranged on the outer detection surface 23 of the sensor element 22, as will be described in greater detail with reference to FIG. 3.

Attached adjacent to the inner surface 24 of the sensor element 22 is a cooling element 30. The cooling element 30 is arranged to decrease, or optionally to increase as will be described below, the temperature T2 of the sensor element 22, and specifically the outer detection surface 23. As has been found by the inventors, an accurate detection of soot particles present in the exhaust gas can be done, and e.g. logged as a function of time. By lowering the temperature T2 of the sensor element 22, the soot particles of the exhaust gas is forced by thermoperesis to the outer detection surface, and in the shown embodiment of the present invention, also to parts of the envelope surface 25, due to the difference in temperature between the exhaust gas and the temperature of the sensor element 22. It should be noted that the temperature difference between the sensor surface and the gas flow (in the proximity of the sensor surface) do not influence the flow rate, however, it has ha very positive effect on the deposition and the deposition rate). The deposition of particles, due to the thermopheresis, results in a particle build up on the outer detection surface 23. The cooling element 30 can be arranged to cool the sensor element 22 to be in the range of between 5-250° C. lower, 5-150° C. lower, optionally at least 5° C. lower, preferably at least 20° C., more preferably at least 30° C. lower, than the ambient exhaust gas. An example of a cooling element is a thermoelectric refrigerator module, or to reach even colder temperatures (a higher delta temperature between the exhaust gas temperature T1 and the temperature of the sensor element T2) multiple thermoelectric refrigerator modules.

Optionally, the cooling element can be provided with a heater (not shown), either as a separate module or an integrated module. The heater is arranged to impart heat to the sensor element 22 to combust the particles which have assembled on the outer detection surface, and to thereby remove the soot particle from the sensor element. Usually this kind of removal of the soot particles is necessary when the sensor element is overloaded with soot particles, e.g. after a long run time of the soot particle sensor arrangement. After removal of the soot particles, the sensor element 22 is ready for attracting new soot particles to continue the measurement and detection of particles. The cooling element and/or the heater are further optionally arranged to an additional insulating layer(s) 26.

The soot particle sensor arrangement 22 is further connected to a computer 34, such as an onboard vehicle computer and/or an Engine Management System (EMS), in the shown embodiment with wires 31, however, a wireless connection, such as Bluetooth or WLAN, is within the boundaries of the present invention. The data collected form the soot particle sensor arrangement 22 is advantageously used to control the parameters which affect the soot particle content of the exhaust gas, or simply to turn on an alert system, e.g. give an audio signal, visual signal or initiate a counter measure or the like, to highlight the conditions present in the exhaust gas. Such condition may for instance be an unacceptable high soot particle content in the exhaust gas. The computer 34 may in turn be connected to other sensors 32, or other control and/or input devices 33 of the vehicle to form a vehicle electronic device network.

As is mentioned, soot particle sensor arrangements, as the one just described can advantageously be arranged on at least one position in the exhaust gas pipeline 4.

As seen in e.g. FIGS. 2 and 3, the soot particle sensor arrangement 20 may further be provided with a detector 40, in the shown embodiment a resistance detector in the form of a first and a second electrode 41, 42 arranged on the outer detection surface 23 of the sensor element 22. The first and the second electrode 41, 42 is in the form of finger electrodes, however, different types of resistance detecting electrodes may be used. As the particles attach to the outer detection surface 23, the resistance between the first and the second electrode 41, 42 decreases, this decrease in resistance can be measured and logged e.g. as a function of time.

The resistance detector 40, the cooling element 24 and/or a heater is connected to a junction box (not shown), preferably arranged inside the insulating layer(s) 26. The wire 31 further connects to the junction box. These connections are conventional and are not described further.

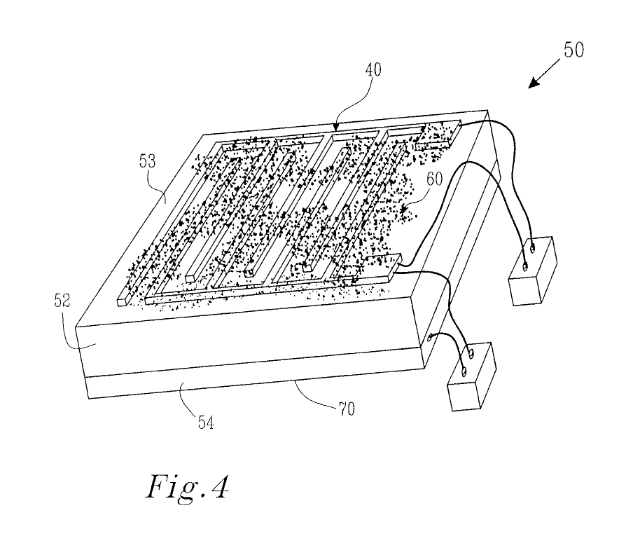

FIG. 4 shows a second embodiment of a soot particle sensor arrangement 50 according to the present invention. As is obvious when reading this description, the soot particle sensor arrangement 50 can be used in the same way and with the same different technical features as the soot particle sensor arrangement described above. More specifically, the soot particle sensor arrangement 50 comprises a detector, similar to the detector 40 comprising a first and a second electrode, as described above. A sensor element 52 with a substantially rectangular form carries the detector on an outer detection surface 53, i.e. the surface of the sensor element intended to be in contact with exhaust gas during use of the sensor arrangement. Further arranged on the outer detection surface 53 are soot particles 60 trapped, forming a particle build up on the surface. A cooling element 70 is arranged opposite the outer detection surface 53, on the inner surface 54, the cooling element is similar as described above.

As an option, a light detector can be used together with a light source instead of the resistance detector as described above. In this embodiment, an appropriate light source with at least one wavelength which is absorbed by the soot particles is chosen. The light waves are transmitted towards the outer detection surface of the sensor element, and the reflecting light is detected by the light detector and logged e.g. as a function of time.

### Soot Particle Detection and Measurements

In the following section the experimental parts will be described in greater detail. A diesel engine exhaust gas was simulated by burning an oxygen/propane gas mixture with a ratio of about 3.5. The value of 3.5 being the oxygen/propane volume (flow values) ratio (one part propane and 3.5 parts oxygen), this is equivalent with a 16.6 air/propane volume (flow) ratio. This rendered an appropriate air deficit as regard to the total burn air necessary for a total combustion. The soot particle arrangement was then exposed to the gas. The flame was readily isolated from the ambient atmosphere in order to control the amount of available air. The produced soot was quenched after obtaining, to avoid agglomeration. Dilution ratios between ⅕ and 1/12 (1 part soot stream to 5 or 12 parts (flow rate) dilution air) gave quite similar results in terms of particle size, i.e. agglomeration could be avoided even at low dilution ratio at quenching;

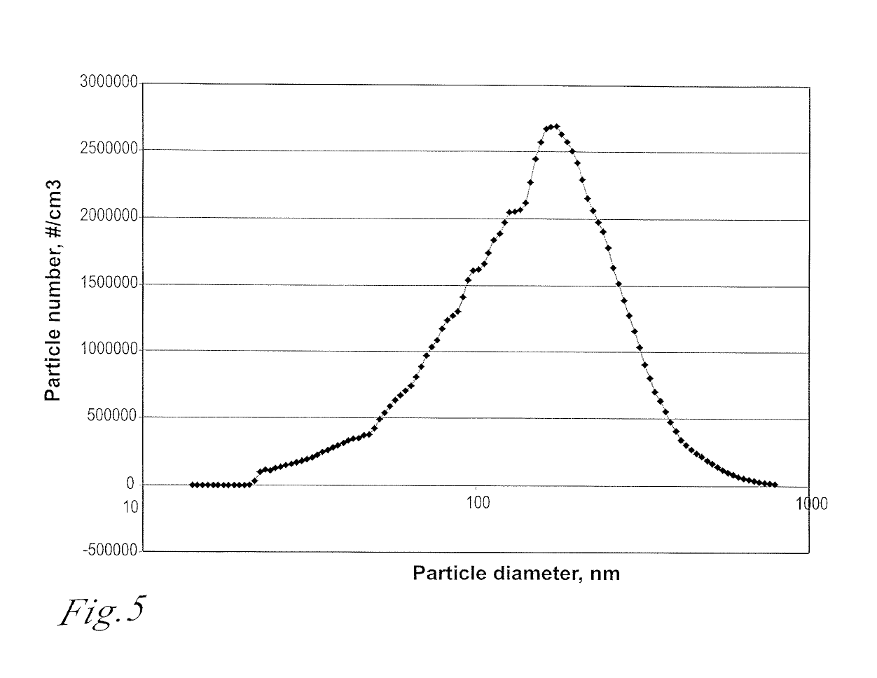

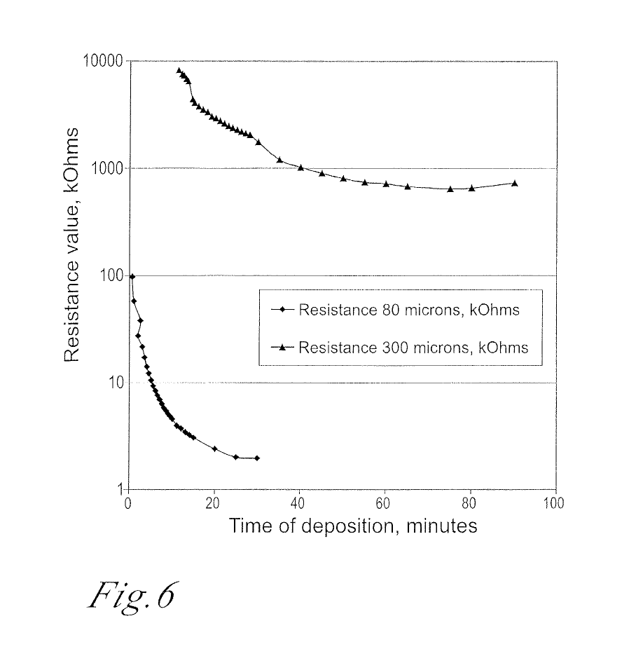

In order to determine proper soot particle size that resembles emitted soot from exhaust of diesel engine, an electrical mobility spectrometer (SMPS) incorporating a Condensation Particle Counter (CPC) was used for determining the particle number size distribution. The dilution ratio mainly depends on the internal nozzle diameter (the one used dilutes at a 1/12 ratio). A typical soot particle number size distribution curve is presented in FIG. 5. The particle number size distribution curve is comparable with that of diesel soot. Turning to FIG. 6. FIG. 6 shows the results obtained from the evaluation of the soot particle sensor arrangement and the method for detecting soot particles, according to one embodiment of the present invention. FIG. 6 shows two different curves derived from measurements with two different distances, 80 and 300 μm respectively, between the first and the second electrode of a resistance detector. As can be seen, fine tuning of the sensor arrangement can be made by adjusting the distance between the first and the second electrode, hence in a preferred embodiment of the present invention, the first and the second electrode of a resistance detector arranged on a sensor element of the soot particle sensor arrangement, is preferably between 1-500 μm, or optionally between 80-300 μm.

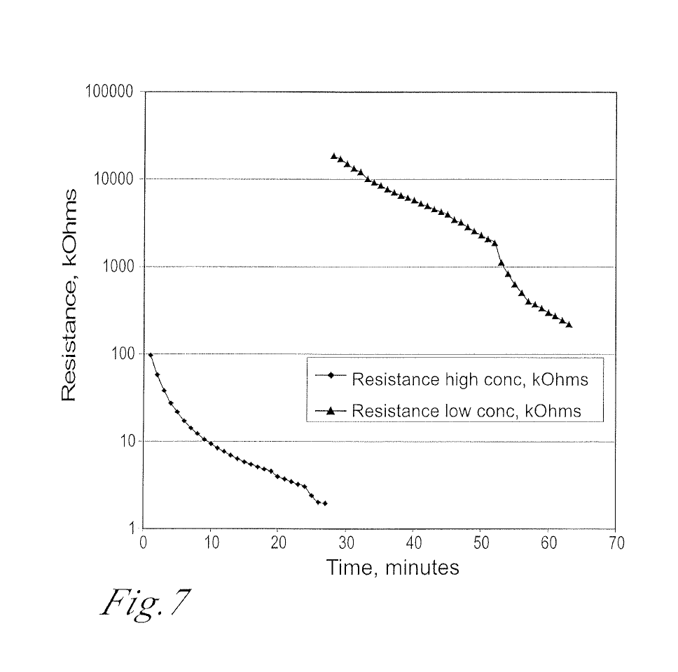

FIG. 7 shows the particle build up on the sensor element, and more specifically on the area covered by the resistance detector 40, as a function of time. It further shows the particle build up at a low and a high concentration of particles in the exhaust gas. A particle build up, i.e. soot deposition on the outer detection surface of the sensor element after a second dilution step also occurs, but a lot slower, and the resistance values remain higher with about two orders of magnitude than the ones obtained with soot diluted just for quenching.

As the experiment continues, it can be seen that the resistance is less reluctant to decrease, without being bound by theory; it is believed that the outer detection surface of the sensor element becomes somewhat saturated with soot particles, which thereby reduces the accuracy of the detection. As a consequence, the outer detection surface of the sensor element, and in the end, the sensor element, needs to be regenerated from the abundant soot particles, preferably it needs to be regenerated so as to remove all of the assembled soot particles. This can be done as described above, by heating the sensor element to a temperature at which the soot particles are combusted. In practice this is a temperature which is higher than the gas temperature. This combustion is preferably catalyzed by a catalyst, e.g. a noble metal, such as platinum, palladium, or any other base metal with catalytic properties, arranged on the surface of the sensor element or be included in the composition of the surface of the sensor element, e.g. in an external layer of the sensor element is such is present. These noble metal catalysts can also be used for increasing the sensing capacity of the sensor.

Other heating methods of the sensor element are of course possible, for instance, the temperature of the exhaust gas can be controlled by configuring the injection of the fuel into the engine, so called post-injection of fuel. This procedure is used to e.g. regenerate diesel particle filters, hence in an embodiment of the present invention, the soot sensor arrangement can be cleaned in this way, simultaneously as a diesel particle filter, or separate. Optionally can a separate burner be arranged to combust the assembled particles from the sensor element. A combination of the above mentioned heating principles are also possible, e.g. can a heater be used together with a post-injection, and/or a separate burner to regenerate the diesel particle filter.

1. Method for detecting particles in a gas flow, said method comprises the steps of;
providing at least one particle sensor arrangement (11, 12, 20, 50), comprising a sensor element (22, 52), said sensor element (22, 52) being at least partly exposed to said gas flow, wherein said gas flow comprises a first temperature (T1) in the proximity of said sensor element (22, 52);
characterized in
that said method further comprises the steps of;
forcing a particle build up on said sensor element (22, 52) of said particle sensor arrangement (11, 12, 20, 50) by regulating said sensor element (22, 52) to a second temperature (T2);
said second temperature (T2) being lower than said first temperature (T1);
and in that said particle build up is detected at said sensor element (22, 52) by means of a detector (40).

2. The method according to claim 1, characterized in that said detection of particle build up is done by means of detecting the resistance between a first and a second electrode (41, 42) at said sensor element (22, 52).

3. The method according to any preceding claims, characterized in that said second temperature (T2) at said sensor element (22, 52) is regulated by means of providing a temperature control arrangement (30, 70) to said sensor element (22,52).

4. The method according to claim 3, characterized in that said temperature control arrangement (30,70) is a cooling element (22, 52), heat exchanger, or the like.

5. The method according to claim 4, characterized in that said temperature control arrangement (30, 70) is a cooling element (22, 52).

6. The method according to any of claims 4-6, characterized in that said temperature control arrangement utilizes a circulating cooling liquid to reduce said temperature.

7. The method according to any preceding claims, characterized in that said second temperature (T2) is regulated to be about 5-250° C. less, preferably 5-150° C. less than said first temperature (T1).

8. The method according to any preceding claims, characterized in that said method further comprises the step of;
removing said particle build up at said sensor element (22, 52) by means of, direct or indirect, heat said sensor element (22, 52) so as to combust substantially all particles of said particle build up at said sensor element (22, 52).

9. The method according to claim 8, characterized in that said heating of said sensor element (22, 52) is done by means of convection from a heater arranged to said sensor element (22, 52).

10. The method according to any of claim 8 or 9, characterized in that said removing of said particle build up is initiated when said particle build up has reached a predetermined threshold value.

11. The method according to any preceding claims, characterized in that said gas flow is an exhaust gas from combustion.

12. The method according to claim 11, characterized in that said exhaust gas is from a combustion present in a power plant, disposal plant, thermal power station, coal power plant, central heater, heating boiler or the like.

13. The method according to claim 12, characterized in that said exhaust gas is from a combustion engine, such as a fossil fuel engine, biomass fuel engine or the like.

14. The method according to claim 13, characterized in that said combustion engine is a diesel combustion engine.

15. The method according to any of claims 1-10, characterized in that said particles is selected from the group of; soot, dust, pollen, color pigments, particles from break systems on vehicles, tire particles from vehicles, or the like, preferred particles are soot particles.

16. The method according to any preceding claims, characterized in that said particle arrangement is used together with a particle filter, to establish or detect a predetermined condition of said particle filter.

17. The method according to any preceding claims, characterized in that said method comprises an initial step of calibrating said sensor arrangement towards a calibration gas flow, said calibration gas flow being created from the combustion of a mixture of a fuel gas and an oxidizing gas with a predetermined ratio, said predetermined ratio being selected to fit said detection of said particles in said gas flow.

18. A particle sensor arrangement for detecting particles in a gas flow, said arrangement (11, 12, 20, 50) comprises;
a sensor element (22, 52) to capture and hold at least a part of said particles of said gas flow, wherein said gas flow comprises a first temperature (T1) in the proximity of said sensor element (22, 52),
a detector, arranged to detect a particle build up on said sensor element (22, 52), characterized in
that said sensor element (22, 52) is arranged to a temperature control arrangement (30, 70),
said temperature control arrangement (30, 70) being arranged to reduce the temperature of said sensor element (22, 52) so that during detection, said sensor element (22, 52) comprises a second temperature (T2) which is lower than said first temperature (T1) of said exhaust gas at said sensor element (22, 52).

19. The particle sensor arrangement according to claim 18, characterized in that said temperature control arrangement (30, 70) comprises a cooling element (30, 70), a heat exchanger or the like.

20. The particle sensor arrangement according to claim 18 or 19, characterized in that said temperature control arrangement (30, 70) is arranged to lower said second temperature (T2) of about 5-250° C., preferably 5-150° C. lower than said first temperature (T1).

21. The particle sensor arrangement according to any of claims 18-20, characterized in that said temperature control arrangement (30, 70) is arranged adjacent to said sensor element (22, 52).

22. The particle sensor arrangement according to any of claims 18-21, characterized in said temperature control arrangement (30, 70) further comprises a heater, said heater being arranged to combust said deposited particles.

23. The particle sensor arrangement according to any of claims 18-22, characterized in that said sensor element (22, 52) comprises an outer detection surface (23, 25, 53), said surface being coated with a noble metal, such as platinum, palladium, to catalyst said combustion of said particles and/or to improve the sensing capacity of the particle sensor arrangement.

24. The particle sensor arrangement according to any of claims 18-23, characterized in that said detector (40) is arranged on said sensor element (22, 52).

25. The particle sensor arrangement according to claim 24, characterized in that said detector (40) comprises a first and a second electrode (41, 42) and in that the resistance between said first and second electrode (41, 42) is detected.

26. The particle sensor arrangement according to any of claims 18-25, characterized in that said gas flow is an exhaust gas from a combustion,

27. The particle sensor arrangement according to any of claims 18-26, characterized in that said exhaust gas is from combustion present in a power plant, disposal plant, thermal power station, coal power plant, central heater, heating boiler or the like.

28. The particle sensor arrangement according to claim 26, characterized in that said exhaust gas is from a combustion engine, such as a fossil fuel engine, biomass fuel engine or the like.

29. The particle sensor arrangement according to claim 28, characterized in that said combustion engine is a diesel combustion engine.

30. The particle sensor arrangement according to any of claims 18-25, characterized in that said particles is selected from the group of; soot, dust, pollen, color pigments, particles from break systems on vehicles, tire particles from vehicles, or the like, preferred particles are soot particles.

31. The particle sensor arrangement according to any of claims 18-30, characterized in that said particle sensor arrangement is integrated with a particle filter.

32. An engine exhaust gas system comprising the particle sensor arrangement according to any of claims 17-30, characterized in that said engine exhaust system (1) comprises an inlet opening (7) and an outlet opening (8), wherein said inlet opening (7) is intended to be connected to an engine gas exhaust port (3).

33. The engine exhaust gas system according to claim 32, characterized in said engine (2) is a diesel engine and in that said engine exhaust system (1) comprises a diesel particle filter (5) and in that said particle sensor arrangement (11, 20, 50) is arranged between said inlet opening (7) and said diesel particle filter (5).

34. The engine exhaust gas system according to claim 32, characterized in that said engine is a diesel engine and in that said engine exhaust system (1) comprises a diesel particle filter (5) and in that said particle sensor arrangement (12, 20, 50) is arranged between said outlet opening (8) and said diesel particle filter (5).

35. The engine exhaust gas system according to claims 33 and 34, characterized in that said engine exhaust system (1) comprises at least two particle sensor arrangements (11, 12, 20, 50), wherein said at least two particle sensor arrangements (11, 12, 20, 50) are arranged on either side of said diesel particle filter (5).

36. A vehicle comprising a diesel engine and the engine exhaust gas system according to any of the claims 32-35.
